(19) United States
(12) Patent Application Publication
(10) Pub. No.: US 2013/0132194 A1
(43) Pub. Date: May 23, 2013

(54) TARGETING ADVERTISEMENTS TO USERS OF A SOCIAL NETWORKING SYSTEM BASED ON EVENTS

(71) Applicant: Giridhar Rajaram, Cupertino, CA (US)

(72) Inventor: Giridhar Rajaram, Cupertino, CA (US)

(21) Appl. No.: 13/299,322

(22) Filed: Nov. 17, 2011

(51) Int. Cl. G06Q 30/02; G06F 15/18; G06N 7/02

(52) U.S. Cl. 705/14.52; 706/12

(57) ABSTRACT

A social networking system enables advertisers to target advertisements to users who are attending events, which may be associated with concepts, temporal information, and locations. Targeting criteria for advertisements may include global events and user-generated events. Using past event attendance history, location information, and social graph information, a social networking system may generate a predictive model to estimate probabilities of whether users will attend an event. Confidence scores may be generated for users for an event based on the predictive model. Advertisements may be targeted to users based on events using the confidence scores. Event attendance by users may be used in a fuzzy matching algorithm by the social networking system in providing advertisements to users of the social networking system.

### BACKGROUND

This invention relates generally to social networking, and in particular to targeting advertisements to users of a social networking system based on events.

Traditional advertisers relied on massive lists of keywords to target audiences based on their interests. For example, a sports drink advertiser may target audiences that are interested in sports, such as baseball, basketball, and football, among others. However, advertisements may be presented in locations and at times where the audiences are not actively engaging in an activity related to the product. This leads to wasted ad spending because audiences may not pay attention to the advertisement for lack of relevance.

In recent years, social networking systems have made it easier for users to share their interests and preferences in real-world concepts, such as their favorite movies, musicians, celebrities, brands, hobbies, sports teams, and activities. These interests may be declared by users in user profiles and may also be inferred by social networking systems. Users can also interact with these real-world concepts through multiple communication channels on social networking systems, including interacting with pages on the social networking system, sharing interesting articles about causes and issues with other users on the social networking system, and commenting on actions generated by other users on objects external to the social networking system. Although advertisers may have some success in targeting users based on interests and demographics, tools have not been developed to target users based on events.

Specifically, users that have indicated intentions to attend events have not been targeted by a social networking system. A social networking system may have millions of users that have expressed intentions to attend events around the world, from small and informal social gatherings to major world events. However, existing systems have not provided efficient mechanisms of targeting advertisements to these users based on events.

### SUMMARY

A social networking system may enable advertisers to target advertisements to users intending to attend events that include concepts, temporal information, and locations. Targeting criteria for advertisements may include worldwide current events and user-generated events. Using past event attendance history, location information, and social graph information, a social networking system may generate a predictive model to estimate probabilities of whether users will attend an event. Confidence scores may be generated for users for an event based on the predictive model. Advertisements may be targeted to users based on events using the confidence scores. Event targeting enables a social networking system to target user intent in real time. In one embodiment, event attendance by users may be used in a fuzzy matching algorithm by the social networking system in providing advertisements to users of the social networking system.

### BRIEF DESCRIPTION OF THE DRAWINGS

FIG. 1 is high level block diagram illustrating a process of targeting advertisements to users of a social networking system based on targeted event criteria, in accordance with an embodiment of the invention.

FIG. 2 is a network diagram of a system for targeting advertisements to users of a social networking system based on targeted event criteria, showing a block diagram of the social networking system, in accordance with an embodiment of the invention.

FIG. 3 is high level block diagram illustrating an event targeting module that includes various modules for targeting advertisements to users of a social networking system based on targeted event criteria, in accordance with an embodiment of the invention.

FIG. 4 is a flowchart of a process of targeting advertisements to users of a social networking system based on targeted event criteria, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the social networking system. Users join the social networking system and add connections to a number of other users to whom they desire to be connected. Users of social networking system can provide information describing them which is stored as user profiles. For example, users can provide their age, gender, geographical location, education history, employment history and the like. The information provided by users may be used by the social networking system to direct information to the user. For example, the social networking system may recommend social groups, events, and potential friends to a user. A social networking system may also enable users to explicitly express interest in a concept, such as celebrities, hobbies, sports teams, books, music, and the like. These interests may be used in a myriad of ways, including targeting advertisements and personalizing the user experience on the social networking system by showing relevant stories about other users of the social networking system based on shared interests.

A social graph includes nodes connected by edges that are stored on a social networking system. Nodes include users and objects of the social networking system, such as web pages embodying concepts and entities, and edges connect the nodes. Edges represent a particular interaction between two nodes, such as when a user expresses an interest in a news article shared by another user about “America's Cup.” The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes of the graph objects and graph actions. For example, a graph object for a movie may have several defined object properties, such as a title, actors, directors, producers, year, and the like. A graph action type, such as “purchase,” may be used by a third-party developer on a website external to the social networking system to report custom actions performed by users of the social networking system. In this way, the social graph may be “open,” enabling third-party developers to create and use the custom graph objects and actions on external websites.

Third-party developers may enable users of the social networking system to express interest in web pages hosted on websites external to the social networking system. These web pages may be represented as page objects in the social networking system as a result of embedding a widget, a social plug-in, programmable logic or code snippet into the web pages, such as an iFrame. Any concept that can be embodied in a web page may become a node in the social graph on the social networking system in this manner. As a result, users may interact with many objects external to the social networking system that are relevant to a keyword or keyword phrase, such as “Justin Bieber.” Each of the interactions with an object may be recorded by the social networking system as an edge. By enabling advertisers to target their advertisements based on user interactions with objects related to a keyword, the advertisements may reach a more receptive audience because the users have already performed an action that is related to the advertisement. For example, a merchandiser that sells Justin Bieber t-shirts, hats, and accessories may target ads for new merchandise to users that have recently performed one of multiple different types of actions, such as listening to Justin Bieber's song “Baby,” purchasing Justin Bieber's new fragrance, “Someday,” commenting on a fan page for Justin Bieber, and attending an event on a social networking system for the launch of a new Justin Bieber concert tour. Enabling third-party developers to define custom object types and custom action types is further described in a related application, “Structured Objects and Actions on a Social Networking System,” U.S. application Ser. No. 13/239,340 filed on Sep. 21, 2011, which is hereby incorporated by reference.

Advertisers may engage with users of a social networking system through different communication channels, including direct advertisements, such as banner ads; indirect advertisements, such as sponsored stories; generating a fan base for a page on the social networking system; and developing applications that users may install on the social networking system. An advertiser would benefit from identifying users that are attending events related to the advertiser's product, brand, application, and the like because advertisers may more effectively target their advertisements. In turn, a social networking system would benefit from increased advertising revenue by enabling advertisers to target users that may attend events related to the advertisers.

A social networking system may receive an event as part of targeting criteria for an advertisement from an advertiser, in one embodiment. For example, an advertiser may wish to target the 2011 Major League Baseball World Series. Users of the social networking system may indicate that they are attending the major event by interacting with various content objects on the social networking system, such as a user submitting an RSVP to an event object for Game 1 of the World Series, a photo uploaded by a user of tickets to the event, a status update mentioning the event by a user, a check-in event at the stadium, an open graph action of purchasing tickets to the World Series on an external website, and the like. Users may also indicate that they are going to watch the World Series at an informal gathering at a user's house. Event targeting criteria may be loosely defined to include a broad range of users that have interacted with objects on the social networking system with respect to the event. As a result, a targeting cluster generated from the targeting criteria may include users attending a specified event, users connected to other users attending the specified event, as well as any user that satisfies a rule including the specified event, such as users creating a check-in event with 50 miles of the event or users mentioning the event in a content post. In another embodiment, user attendance to events may be used by a social networking system as a feature in a fuzzy matching algorithm that targets advertisements from advertisers to users of the social networking system based on the content of the advertisements and the interests of users. Because an event includes a temporal component and a geographic location component, in addition to a conceptual component, a social networking system may deliver timely advertisements based on information about users' attendance at events.

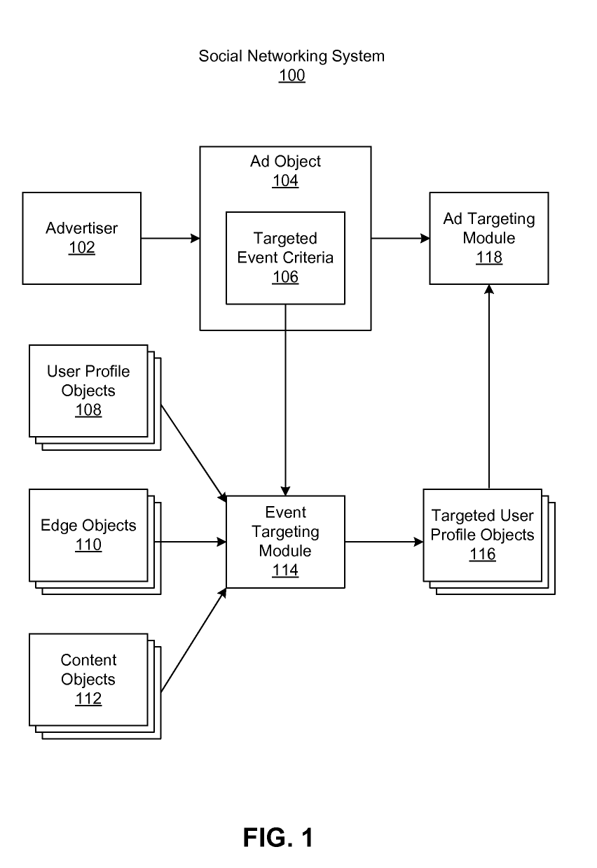

FIG. 1 illustrates a high level block diagram of a process of targeting advertisements to users of a social networking system based on targeted event criteria, in one embodiment. The social networking system 100 includes an advertiser 102 that provides an ad object 104 that includes targeted event criteria 106 to the social networking system 100. The targeted event criteria 106 may include any type of event, including major world events such as Hurricane Irene, Arab Spring, international sporting events, as well as smaller user-generated events such as a night out on the town, a small gathering at a user's house to watch the Super Bowl, and a meeting at a coffee shop for a group of users that are interested in a local political campaign. The social networking system 100 may enable the targeted event criteria 106 to be as specific or as broad as desired by the advertiser 102. In one embodiment, specific events, such as the San Francisco Giants vs. the San Diego Padres baseball game at 7:15 PM PST on Sep. 13, 2011, may be included in the targeted event criteria 106. In another embodiment, types of events, such as cocktail parties, movie night get-togethers, and dinner parties, may also be specified by the targeted event criteria 106. In another embodiment, the advertiser 102 may provide an ad object 104 without targeted event criteria 106. In that embodiment, the ad targeting module 118 may analyze the content of the ad object 104 to target the advertisement based on a fuzzy matching algorithm that may use event attendance information as a feature.

The targeted event criteria 106 is received by an event targeting module 114. The event targeting module 114 analyzes information about users of the social networking system 100 to determine targeted users that have indicated intentions to attend the event described in the targeted event criteria 106 as well as targeted users that may be inferred to have intentions to attend the event described in the targeted event criteria 106. The event targeting module 114 retrieves information about users from user profile objects 108, edge objects 110, and content objects 112. User profile objects 108 include declarative profile information about users of the social networking system 100. Edge objects 110 include information about user interactions with other objects on the social networking system 100, such as clicking on a link shared with the viewing user, sharing photos with other users of the social networking system, posting a status update message on the social networking system 100, and other actions that may be performed on the social networking system 100. Content objects 112 include event objects created by users of the social networking system 100, status updates that may be associated with event objects, photos tagged by users to be associated with other objects in the social networking system 100, such as events, pages, and other users, and applications installed on the social networking system 100.

The event targeting module 114 analyzes the information about the users of the social networking system 100 retrieved from the user profile objects 108, edge objects 110, and content objects 112 to identify targeted user profile objects 116 that have been determined to have intentions to attend the event specified in the targeted event criteria 106. The event targeting module 114 may also infer intentions to attend the event specified in the targeted event criteria 106 for identified targeted user profile objects 116 based on information in the user profile objects 108, edge objects 110, and content objects 112, such as past check-in events at the same location as the event specified in the targeted event criteria 106, other users connected to the inferred targeted user indicating that they are attending the event, and location information retrieved about users that are within a predetermined radius of the event. In one embodiment, confidence scores may be generated for user profile objects 108 based on the analyzed information about the users of the social networking system 100 to determine probabilities that users will attend the event. In that embodiment, a predetermined threshold confidence score may be used to infer that targeted users may attend the event. Machine learning algorithms may be used in generating the confidence scores based on the information received about users.

In one embodiment, a temporal proximity analysis may be performed by the event targeting module 114 to determine the targeted user profile objects 116. For example, a user may be determined to be located within a mile of the event just one hour prior to the start of the event. In that case, the temporal proximity of the user is very close to the event, so a greater confidence score may be assigned to that user. In another example, a user may be located within a mile of the event a week before the start of the event. In that case, the temporal proximity of the user is not less close, so a lower confidence score may be assigned to that user. In one embodiment, temporal proximity analysis may be performed as part of a fuzzy matching algorithm for targeting an advertisement to a user. In another embodiment, temporal proximity analysis may be used by the social networking system 100 in modifying bids for ads, such that timelier, and therefore more relevant, advertisements have higher bid prices for users with a closer temporal proximity to the event specified in the targeted event criteria 106. As a result, the overall bid will change based on temporal proximity. In addition, the bid may change on a per user basis based on the geographical proximity of the user to the event, based on location information received about the user. In another embodiment, the bid may change on a per user basis based on an affinity of the user for the event based on sentiment analysis, analyzing the frequency of status updates and past history of user interaction with similar events to determine the affinity of the user for the event. In yet another embodiment, a social networking system may identify groups of users who are attending the event through an analysis of the group's communications. In addition, the group of users may also check into the event together, causing the bid to change for that group of users.

An ad targeting module 118 receives the targeted user profile objects 116 identified by the event targeting module 114 for providing the advertisement embodied in the ad object 104 to the users associated with the targeted user profile objects 116. The advertisement may be provided to users of the social networking system 100 through multiple communication channels, including mobile devices executing native applications, text messages to mobile devices, websites hosted on systems external to the social networking system 100, and ad delivery mechanisms available on the social networking system 100, such as sponsored stories, banner advertisements, and page posts.

System Architecture

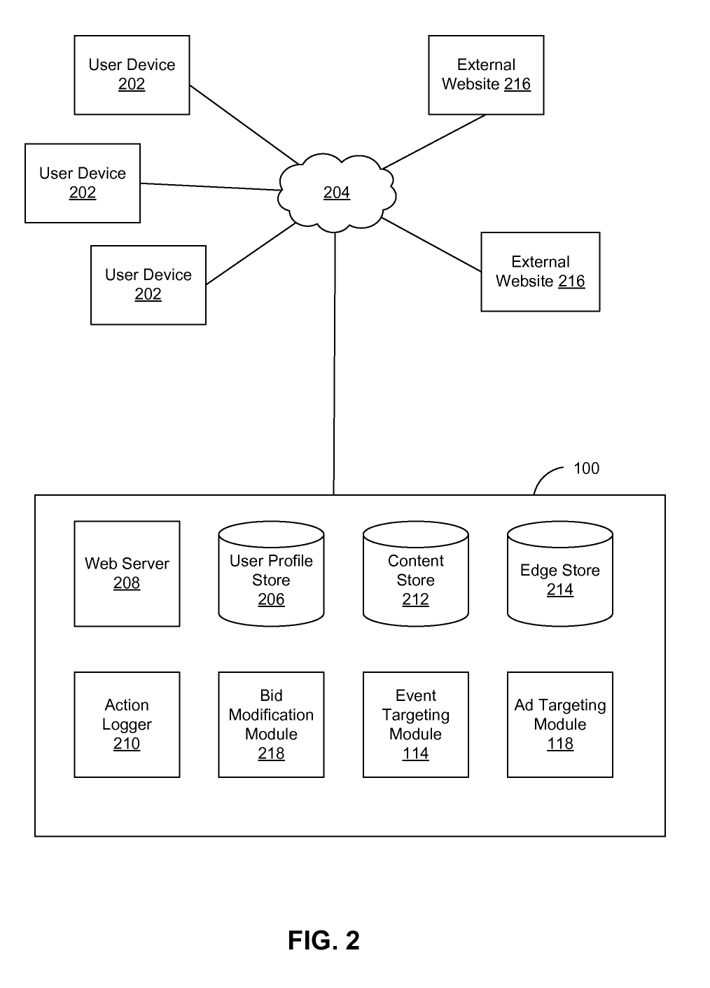

FIG. 2 is a high level block diagram illustrating a system environment suitable for enabling preference portability for users of a social networking system, in accordance with an embodiment of the invention. The system environment comprises one or more user devices 202, the social networking system 100, a network 204, and external websites 216. In alternative configurations, different and/or additional modules can be included in the system.

The user devices 202 comprise one or more computing devices that can receive user input and can transmit and receive data via the network 204. In one embodiment, the user device 202 is a conventional computer system executing, for example, a Microsoft Windows-compatible operating system (OS), Apple OS X, and/or a Linux distribution. In another embodiment, the user device 202 can be a device having computer functionality, such as a personal digital assistant (PDA), mobile telephone, smart-phone, etc. The user device 202 is configured to communicate via network 204. The user device 202 can execute an application, for example, a browser application that allows a user of the user device 202 to interact with the social networking system 100. In another embodiment, the user device 202 interacts with the social networking system 100 through an application programming interface (API) that runs on the native operating system of the user device 202, such as iOS and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the social networking system 100. The social networking system 100 includes a user profile store 206, an event targeting module 114, an ad targeting module 118, a web server 208, an action logger 210, a content store 212, an edge store 214, and a bid modification module 218. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 208 links the social networking system 100 via the network 204 to one or more user devices 202; the web server 208 serves web pages, as well as other web-related content, such as Java, Flash, XML, and so forth. The web server 208 may provide the functionality of receiving and routing messages between the social networking system 100 and the user devices 202, for example, instant messages, queued messages (e.g., email), text and SMS (short message service) messages, or messages sent using any other suitable messaging technique. The user can send a request to the web server 208 to upload information, for example, images or videos that are stored in the content store 212. Additionally, the web server 208 may provide API functionality to send data directly to native user device operating systems, such as iOS, ANDROID, webOS, and RIM.

The action logger 210 is capable of receiving communications from the web server 208 about user actions on and/or off the social networking system 100. The action logger 210 populates an action log with information about user actions to track them. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

An action log may be used by a social networking system 100 to track users' actions on the social networking system 100 as well as external websites that communication information back to the social networking system 100. As mentioned above, users may interact with various objects on the social networking system 100, including commenting on posts, sharing links, and checking-in to physical locations via a mobile device. The action log may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log records data about these users, including viewing histories, advertisements that were clicked on, purchasing activity, and buying patterns.

User account information and other related information for users are stored as user profile objects 108 in the user profile store 206. The user profile information stored in user profile store 206 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. The user profile store 206 also maintains references to the actions stored in an action log and performed on objects in the content store 212.

The edge store 214 stores the information describing connections between users and other objects on the social networking system 100 in edge objects 110. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. The edge store 214 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. Multiple interactions between a user and a specific object may be stored in one edge object in the edge store 214, in one embodiment. For example, a user that plays multiple songs from Lady Gaga's album, “Born This Way,” may have multiple edge objects for the songs, but only one edge object for Lady Gaga.

An event targeting module 114 receives targeted event criteria 106 included in ad objects 104 that are stored in the content store 212, in one embodiment. Using information about users of the social networking system 100, from user profile objects 108 retrieved from the user profile store 206, edge objects 110 retrieved from the edge store 214, and content objects 112 retrieved from the content store 212, the event targeting module 114 may determine confidence scores that measure the likelihood that users may attend the event described in the targeted event criteria 106. Machine learning algorithms may be used to generate confidence scores based on past histories of users' behaviors in attending events. Additionally, machine learning algorithms may infer the attendance of users at events based on the information retrieved about the users and analysis of the temporal proximity of the users with respect to the events. As a result, the event targeting module 114 may identify users that are associated with the event described in the targeted event criteria 106.

An ad targeting module 118 may receive targeting criteria for advertisements for display to users of a social networking system 100. The ad targeting module 118 provides advertisements to users of the social networking system 100 based on the targeting criteria of the advertisements. In one embodiment, targeted event criteria 106 may be received for advertisements and processed by the event targeting module 114. After the event targeting module 114 identifies users that are associated with the event described in the targeted event criteria 106, the ad targeting module 118 may target the advertisement to those identified users. Targeting criteria may also be received from advertisers to filter users by demographics, social graph information, and the like. Other filters may include filtering by interests, applications installed on the social networking system 100, groups, networks, and usage of the social networking system 100.

A bid modification module 218 may adjust bids for advertisements based on a number of factors. In one embodiment, a social networking system 100 may enable advertisers to modify a maximum bid for a click for users depending on temporal proximity analysis of the users. For example, an advertiser for parking garages near a sporting event stadium may wish to target an advertisement for the parking garages to users that intend to attend a game at the sporting event stadium. The advertiser may decide to increase their bid based on how close to the event users are in terms of temporal proximity, such as a check-in event near the stadium a day before the event and a status message update hours before the event. In another embodiment, the social networking system 100 may increase the bid price for users that are in close temporal proximity to an event because those users are more valuable based on their close temporal proximity to the event. In other embodiments, the bid modification module 218 may adjust bids for advertisements based on other factors, including the temporal proximity of users. Other factors used by the bid modification module 218 may include ad inventory, user behavior patterns, and location proximity of users. As a result, advertisers may reach more relevant audiences while the social networking system may benefit from increased engagement and advertising revenues.

Event Targeting on a Social Networking System

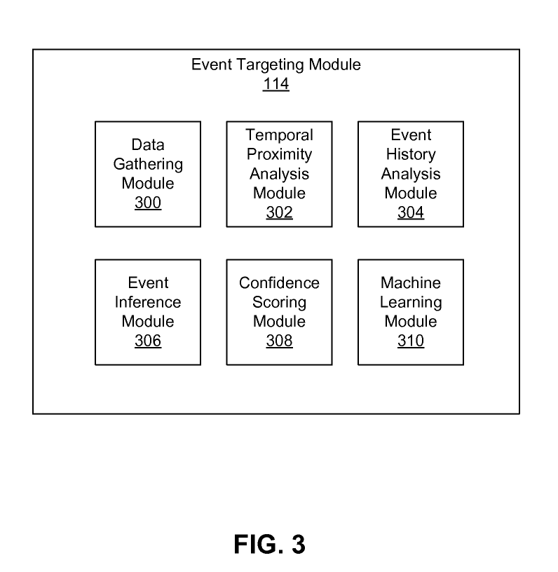

FIG. 3 illustrates a high level block diagram of the event targeting module 114 in further detail, in one embodiment. The event targeting module 114 includes a data gathering module 300, a temporal proximity analysis module 302, an event history analysis module 304, an event inference module 306, a confidence scoring module 308, and a machine learning module 310. These modules may perform in conjunction with each other or independently to develop a confidence scoring model for determining confidence scores for users to be targeted in a social networking system 100 based on the event targeting criteria.

A data gathering module 300 retrieves information about users with respect to an event described in targeted event criteria 106 in an ad object 104, including information from user profile objects 108, edge objects 110, and content objects 112. The data gathering module 300 may retrieve user profile objects 108 that are associated with an event object matching the event described in the targeted event criteria 106 for users that have indicated that they will be attending the event. The data gathering module 300 may also retrieve user profile objects 108 associated with users that have mentioned the event in a content post, such as a status update, comment, or photo upload. In another embodiment, the data gathering module 300 may retrieve user profile objects 108 of other users connected to users that are attending the event. In yet another embodiment, user profile objects 108 may be retrieved by the data gathering module 300 according to a temporal component, a geographic location component, and a conceptual component of the users matching the event described in the targeted criteria 106 in the ad object 104. For example, if an advertisement targeted a Major League Baseball game for the Giants vs. the Rockies that was happening within a day of a user's check-in event at a bar near the stadium where the game would be held, and if that user expressed an interest in the Giants, then the user profile object 108 for that user may be retrieved by the data gathering module 300 because the temporal component, the geographic location component, and the conceptual component of the user matches the event.

A temporal proximity analysis module 302 analyzes information about users of the social networking system 100 and their temporal proximity to an event described in targeted event criteria 106 of an ad object 108. In one embodiment, the temporal proximity analysis module 302 determines a temporal proximity for users associated with the user profile objects 108 retrieved by the data gathering module 300. Temporal proximity may be defined as a metric that measures the distance in temporal units between a user interested in a concept embodied in an event and the time of the event. For example, a status update that is posted by a user on the social networking system 100 that is related to baseball may have a close proximity to a baseball game if the status update was posted just hours before the baseball game. A video upload of a little league baseball game by a user that was posted a month before the baseball game, on the other hand, may not have a close proximity. The temporal proximity analysis module 302 may perform a temporal proximity analysis as part of a confidence scoring model that determines a confidence score for users that they will be attending the event. In another embodiment, the temporal proximity analysis module 302 may provide temporal proximity analysis for users of the social networking system 100 to the bid modification module 218 to modify bids for users with a close temporal proximity to events. In a further embodiment, temporal proximity analysis of users may be used in a fuzzy matching algorithm to target users.

An event history analysis module 304 determines an analysis of the past event attendance history of users associated with retrieved user profile objects 106 by the data gathering module 300. In one embodiment, an event attendance history of each user associated with the retrieved user profile objects 106 is analyzed by the event history analysis module 304 in conjunction with the machine learning module 310 and the confidence scoring module 308 to determine a confidence score that each user will attend the event described in the targeted event criteria 106. Attendance at an event for a user may be inferred by the event inference module 306 based on location proximity, temporal proximity to the event, as well as the event history analysis of the user, in one embodiment.

An event inference module 306 determines users that may be inferred to attend an event described in targeted event criteria 106 associated with an ad object 108. A prediction model may be generated for an event described in the targeted event criteria 106 based on a number of factors, including a user's past event attendance history, behavior patterns of the user with respect to usage on the social networking system 100, and other characteristics of the user.

A confidence scoring module 308 may be used to determine confidence scores for users of the social networking system based on an event attendance prediction model for an event described in targeted event criteria 106. Confidence scores may be determined based on whether users exhibit features in the event attendance prediction model. As a user exhibits more features in the prediction model for an event, the confidence score for that user increases. In one embodiment, an event attendance prediction model includes features that are unique to the event. For example, a Major League Baseball game that is being targeted in San Francisco, CA may have unique features in the event attendance prediction model for the game in San Francisco, CA versus another Major League Baseball game in San Diego, CA because the San Francisco Giants have been having record attendance, selling out most games. As a result, a user that may mention that they are attending a San Francisco Giants game in a comment, status update, or content item may have a high probability of attending the event simply because of the past history of attendance of Giants fans as indicated on the social networking system 100. A similar comment by a Padres fan, on the other hand, may not result in as high of a probability of the user attending event because a different prediction model may be used. In another embodiment, a prediction model for predicting users' attendance at events may be standardized for all events, including features such as users' past history of attendance at events based on check-in event history, as well as location confirmation using Global Positioning System capabilities on mobile devices. Other features may include other information about users, such as location information from content items, keywords extracted from content items, whether users are connected to other users that are attending the event, and whether information about the user indicates that the user is interested in the same concept at the same location and at the same time as the concept, location, and time described in the event.

A machine learning module 310 is used in the event targeting module 114 to select features for prediction models generated for event attendance of events described in targeting criteria. In one embodiment, a social networking system 100 uses a machine learning algorithm to analyze features of a prediction model for predicting event attendance for users of the social networking system 100. The machine learning module 310 may select user characteristics as features for the prediction model for an event, such as past user attendance for events, level of interest in the concept embodied in the event, whether other users connected to a user are attending the event, and whether information about a user indicating a time, location, and concept matches the time, location, and concept described in the event, using at least one machine learning algorithm. In another embodiment, a machine learning algorithm may be used to optimize the selected features for the prediction model based on conversion rates of advertisements targeted to users identified from the prediction model. A selected feature may be removed based on a lack of engagement by users that exhibit the selected feature. For example, a selected feature for a prediction model may include a high affinity score for Starbucks Coffee based on numerous check-in events at Starbucks Coffee locations. However, suppose users exhibiting a high confidence score for checking into a Starbucks Coffee location in the next week based on numerous check-in events at Starbucks Coffee locations do not engage with the advertisement in expected numbers. The machine learning algorithm may deselect that feature, the numerous check-in events, in the prediction model for determining confidence scores for users, in one embodiment. In another embodiment, the confidence score may be reduced by decreasing the weight placed on the check-in events. User feedback mechanisms may include a social networking system enabling users to interact with the advertisement, such as clicking on a link to “X-out” the advertisement. This interaction informs the social networking system that the user was not interested in the advertisement, finding the ad offensive, repetitive, misleading, or not applicable to the user. Another user feedback mechanism includes the social networking system analyzing further content items authored by users attending the event after the event has finished, such as status updates, page posts, photo uploads, check-in events, and adding new connections on the social networking system. Through this content analysis, valuable user feedback may be obtained.

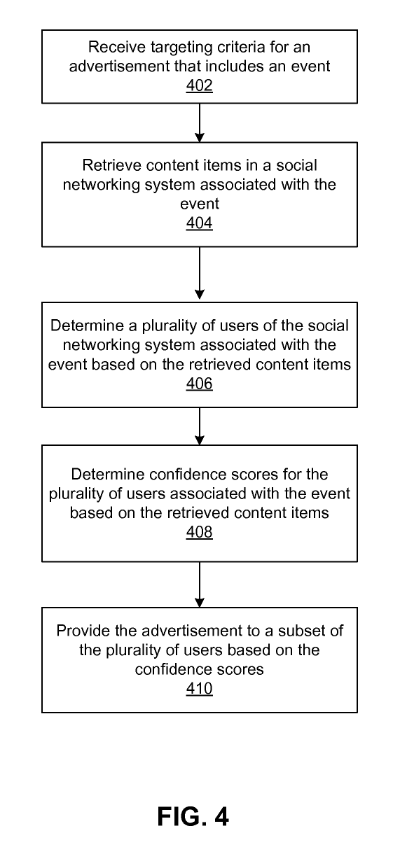

FIG. 4 illustrates a flow chart diagram depicting a process of targeting advertisements to users of a social networking system based on targeted event criteria, in accordance with an embodiment of the invention. A social networking system 100 receives 402 targeting criteria for an advertisement that includes an event. The event included in the targeting criteria may represent a recurring event, such as a daily visit to Starbucks in the morning, a weekly run around a golf course, or a nightly visit to a local pub, in one embodiment. In another embodiment, the event described in the targeting criteria for an advertisement includes a specific event, such as a music concert for a touring group, such as Britney Spears, that is happening on a specific night at a specified location.

Content items in a social networking system associated with the event are retrieved 404. For example, a status message update that includes the name of the artist playing in the music concert event may be retrieved 404. Other types of content items, including page posts, video uploads, check-in events, application installations, and application updates made on behalf of the user may also be retrieved 404. Additionally, content items that are associated with the event as a result of a mention of the event within the content item or otherwise linked to the event may also be retrieved 404. For example, a user may mention the event described in the targeting criteria in a comment to a content item posted on another user's profile. As a result, the content item maybe retrieved even though the content item may not have mentioned the event. In one embodiment, a content item may be associated with an event object based on an association made by a user of the social networking system. In that embodiment, the content item associated with an event object for an event described in the targeting criteria would also be retrieved 404.

After the content items in a social networking system associated with the event have been retrieved 404, the social networking system determines 406 a plurality of users of the social networking system associated with the event based on the retrieved content items. In the social networking system 100, the retrieved content items are associated with users of the social networking system 100 that authored the content items. Those users are determined 406 by the social networking system to be associated with the event. In another embodiment, other users connected to the users that authored the retrieved content items may also be determined 406 to be associated with the event. The other users connected to the users attending the event may be determined 406 to be associated with the event because of the indication of intent to attend the event demonstrated by the users planning to attend the event. In addition, the social networking system 100 may determine 406 a plurality of users of the social networking system to be associated with the event based on a rule that uses the event. For example, users that are located within 50 miles of the event may be determined 406 to be associated with the event because a rule may be programmed to target those users.

After the plurality of users of the social networking system associated with the event based on the retrieved content items has been determined 406, confidence scores are determined 408 for the plurality of users based on the retrieved content items. Confidence scores may be determined 408 based on a number of factors in an event attendance prediction model, including users' past event attendance history, geographic location confirmation using Global Positioning System capabilities on mobile devices, location information from content items, keywords extracted from content items, whether users are connected to other users that are attending the event, and whether information about the user indicates that the user is interested in the same concept at the same location and at the same time as the concept, location, and time described in the event. In another embodiment, the event attendance prediction model may be customized for the type of event being targeted. For example, sporting events may heavily weight an interest in the sport based on content items posted by users that include a mention of the sport, one or more sporting teams in the event, as well as applications installed on the social networking system 100 by the users that are targeted to that sport.

Once confidence scores are determined 408 for the plurality of users associated with the event, the advertisement is provided 410 to a subset of the plurality of users based on the confidence scores. The advertisement may be provided 410 for display to a subset of the plurality of users based on a predetermined threshold confidence score. For example, a confidence score of 60% may be required to provide 410 the advertisement to a user of the social networking system 100. The predetermined threshold confidence score may be determined by administrators of a social networking system 100, in one embodiment, based on empirical data regarding the effectiveness of the targeting of prior advertisements. In another embodiment, the predetermined threshold confidence score may be determined by the advertiser of the advertisement. In a further embodiment, a sample of the plurality of users are provided the advertisement based on confidence scores and other information known about users, such as close geographical proximity to the event and close temporal proximity to the event.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving targeting criteria for an advertisement on a social networking system, where the targeting criteria specifies an event;
retrieving a plurality of content items associated with a plurality of users of the social networking system, where the plurality of content items are associated with the event;
determining a targeting cluster of users associated with the event for the advertisement based on the retrieved plurality of content items;
determining a plurality of confidence scores for the targeting cluster of users associated with the event based on the retrieved content items; and
for a viewing user, providing the advertisement for display to the viewing user based on the viewing user being in the targeting cluster of users and based on the confidence score of the viewing user.

2. The method of claim 1, wherein determining a targeting cluster of users associated with the event based on the retrieved plurality of content items further comprises:
receiving identifying information of users of the social networking system that are attending the event.

3. The method of claim 1, wherein determining a targeting cluster of users associated with the event based on the retrieved plurality of content items further comprises:
receiving identifying information of users of the social networking system that are associated with other users that are attending the event.

4. The method of claim 1, wherein a retrieved content item further comprises a check-in event received from a user device associated with a user of the social networking system.

5. The method of claim 1, wherein a retrieved content item further comprises geographic location information received from a user device associated with a user of the social networking system.

6. The method of claim 1, wherein a retrieved content item further comprises an indication received from a user device associated with a user of the social networking system that the user is attending the event.

7. The method of claim 1, wherein a retrieved content item further comprises a mention of the event received from a user device associated with a user of the social networking system.

8. The method of claim 1, wherein a retrieved content item further comprises geographic positioning system (GPS) information received from a user device associated with a user of the social networking system.

9. The method of claim 1, wherein determining a plurality of confidence scores for the targeting cluster of users associated with the event based on the retrieved content items further comprises:
generating a confidence scoring model for the advertisement based on the retrieved content items associated with the event; and
for each user of the targeting cluster of users, determining a confidence score based on the confidence scoring model and the retrieved content items for the user.

10. The method of claim 1, wherein providing the advertisement for display to the viewing user further comprises:
retrieving a predetermined threshold confidence score for the advertisement; and
responsive to the confidence score of the viewing user exceeding the predetermined threshold confidence score for the advertisement, providing the advertisement for display to the viewing user.

11. A method comprising:
maintaining a plurality of user profile objects on a social networking system, the plurality of user profile objects representing a plurality of users of the social networking system;
maintaining a plurality of edge objects connecting the plurality of user profile objects and a plurality of nodes in the social networking system, where a subset of the plurality of nodes represent a plurality of events;
determining a prediction model for scoring a plurality of advertisements for each user of the plurality of users where the prediction model includes at least one of the plurality of events as a feature in the prediction model;
determining a plurality of prediction scores for the plurality of advertisements for each user of the plurality of users based on the prediction model; and
for a viewing user of the social networking system, providing an advertisement for display to the viewing user based on the prediction score of the advertisement.

12. The method of claim 11, wherein a subset of the plurality of edge objects are generated based on a plurality of graph actions performed by a subset of the plurality of users on a plurality of graph objects on external systems, the plurality of graph actions and the plurality of graph objects defined by a plurality of entities external to the social networking system.

13. The method of claim 11, wherein the prediction model comprises a machine learning model.

14. The method of claim 11, wherein determining a prediction model for scoring a plurality of advertisements for each user of the plurality of users where the prediction model includes at least one of the plurality of events as a feature in the prediction model further comprises:
generating the prediction model using a fuzzy matching algorithm; and
determining the feature in the prediction model as at least one of the plurality of events based on information about an event received from a user of the plurality of users.

15. The method of claim 11, wherein determining a prediction model for scoring a plurality of advertisements for each user of the plurality of users further comprises:
receiving a performance metric for a feature in the prediction model; and
modifying the prediction model based on the performance metric for the feature.

16. A method comprising:
maintaining a plurality of user profile objects on a social networking system, the plurality of user profile objects representing a plurality of users of the social networking system;
receiving an advertisement having targeting criteria comprising a temporal component, a geographic location component, and a conceptual component;
retrieving a plurality of edge objects on the social networking system associated with a subset of the plurality of users where each edge object is associated with the temporal component, the geographic location component, and the conceptual component of the targeting criteria of the advertisement;
determining a targeting cluster of users of the social networking system for the advertisement based on the subset of the plurality of users of the social networking system associated with the plurality of edge objects;
determining a plurality of prediction scores for the advertisement for the targeting cluster of users based upon a prediction model for scoring the advertisement; and
for a viewing user of the social networking system in the targeting cluster of users, providing the advertisement for display to the viewing user based on a prediction score for the advertisement for the viewing user.

17. The method of claim 16, wherein determining a plurality of prediction scores for the advertisement for the targeting cluster of users further comprises:
for each user of the targeting cluster of users, determining a temporal proximity of the user with respect to the temporal component of the targeting criteria of the advertisement; and
determining the prediction score for the advertisement for each user of the targeting cluster of users based on the temporal proximity of the user.

18. The method of claim 16, wherein determining a plurality of prediction scores for the advertisement for the targeting cluster of users further comprises:
for each user of the targeting cluster of users, determining a geographic location proximity of the user with respect to the geographic location component of the targeting criteria of the advertisement; and
determining the prediction score for the advertisement for each user of the targeting cluster of users based on the geographic location proximity of the user.

19. The method of claim 16, wherein determining a plurality of prediction scores for the advertisement for the targeting cluster of users further comprises:
for each user of the targeting cluster of users, determining an affinity score of the user with respect to the conceptual component of the targeting criteria of the advertisement; and
determining the prediction score for the advertisement for each user of the targeting cluster of users based on the affinity score of the user with respect to the conceptual component of the targeting criteria of the advertisement.

20. The method of claim 16, wherein the prediction model for scoring the advertisement includes the temporal component, the geographic location component, and the conceptual component of the targeting criteria of the advertisement as features of the prediction model.

21. The method of claim 16, further comprising:
receiving information about a particular user with respect to the targeting criteria of the advertisement;
determining a proximity of the particular user with respect to the temporal component, the geographic location component, and the conceptual component of the targeting criteria of the advertisement; and
modifying a bid price for the particular user for targeting the advertisement based on the determined proximity of the particular user.

22. The method of claim 16, wherein determining a plurality of prediction scores for the advertisement for the targeting cluster of users further comprises:
for each user in the targeting cluster of users, determining a frequency of the user interacting with the conceptual component of the targeting criteria based on the edge objects associated with the user; and
determining a prediction score for the advertisement for each user in the targeting cluster of users based on the determined frequencies.
